(19) United States
(12) Patent Application Publication
(10) Pub. No.: US 2014/0006586 A1
(43) Pub. Date: Jan. 2, 2014

(54) METHOD FOR SUPPORTING THE MOBILITY OF A DEVICE IN A 6LOWPAN-BASED WIRELESS SENSOR NETWORK

(71) Applicants: Choong Seon Hong, Yongin-si (KR); Jin Ho Kim, Goyang-si (KR); Jun Lee, Jeonju-si (KR); Hyung Kyu Kang, Seogwipo-si (KR)

(72) Inventors: Choong Seon Hong, Yongin-si (KR); Jin Ho Kim, Goyang-si (KR); Jun Lee, Jeonju-si (KR); Hyung Kyu Kang, Seogwipo-si (KR)

(73) Assignee: UNIVERSITY-INDUSTRY COOPERATION GROUP OF KYUNG-HEE UNIVERSITY ET AL, Yongin-si Gyeonggi-Do (KR)

(21) Appl. No.: 13/990,731

(22) PCT Filed: Aug. 25, 2011
(86) PCT No.: PCT/KR2011/006265

§ 371 Date: Jul. 23, 2013

(30) Foreign Application Priority Data
Nov. 30, 2010 (KR) 10-2010-0120852

(51) Int. Cl. H04L 12/24

(52) U.S. Cl. CPC H04L 41/00
USPC 709/223

(57) ABSTRACT

The present invention relates to a method for supporting the mobility of a device in an Internet Protocol version 6 (IPv6)-based wireless sensor network, and more particularly, to a method for supporting the mobility of a device by separating the identifier (ID) and the locator of the device in an IPv6 Low-power Wireless Personal Area Network (6LoWPAN)-based wireless sensor.

### TECHNICAL FIELD

The present invention relates to a method of supporting mobility of a device in a wireless sensor network based on Internet Protocol Version 6 (IPv6), and more specifically, to a method of supporting mobility of a device by separating an identifier (ID) and a locator of the device in a wireless sensor network based on IPv6 Low-power Wireless Personal Area Network (6LoWPAN).

### BACKGROUND ART

A sensor network is one of the most important techniques that will be used as a base environment in a ubiquitous society. In order to more efficiently manage such a sensor network, interconnection between the sensor network and an IP network is emerged as a prerequisite condition. In line with such a trend, IPv6 over Low power WPAN (6LoWPAN) has been developed by an IETF working group in order to use TCP/IP on IEEE 802.15.4. That is, the 6LoWPAN refers to a technique for mounting Internet Protocol Version 6 (IPv6) on a low power Wireless Personal Area Network (WPAN) using IEEE 802.15.4 as the PHY/MAC layers. Generally, the 6LoWPAN includes devices which operate together so as to be physically connected to an application environment of a real world. A typical example of the devices may be a mobile sensor node or a mobile network (Network Mobility, NEMO).

Here, the NEMO supports network level mobility through a mobile router (MR) when a network moves, and provides consistent Internet connection to a variety of mobile terminals and stationary terminals existing in a subnet inside the MR. The MR of the NEMO includes at least two network interfaces divided into an egress interface and an ingress interface. The egress interface connects to an external network or another NEMO to support network mobility, and the ingress interface configures a subnet inside the MR.

The mobile sensor node and the NEMO based on the 6LoWPAN described above are techniques based on an IP architecture conforming to the TCP/IP hierarchical model. TCP/IP is a network transmission protocol used as a standard protocol for information transmission on the Internet since data may be transmitted between computers using different operating systems. TCP is a protocol for dividing a transmission data into packets of a predetermined size and enveloping the divided packets, and IP is a protocol for directly transmitting and receiving data. All computers connected to the Internet conform to the standard developed by the Internet standard committee, and the Internet standard protocol is TCP/IP. The aim of the TCP/IP hierarchical model is to open communication among different systems without any logical change in hardware or software. The hierarchical structure of the TCP/IP hierarchical model includes a physical layer L1 as a first layer, a data link layer L2 as a second layer, a network layer L3 as a third layer, and a transport layer L4 as a fourth layer.

The TCP/IP hierarchical model will be described hereinafter with reference to FIG. 1.

The network layer performs a function of establishing a logical link to transmit data from a transmission sensor node to a receiving side terminal, dividing an upper layer data into packets of a smaller size, and transmitting the packets in the unit of network. Meanwhile, the transport layer performs a function of locating an error from a data transmitted and received in the network layer, and transmitting and receiving the data between the transmission sensor node and the receiving side terminal, i.e., between end points, without an error. In addition, the application layer provides a means for accessing a network so that data may be exchanged between the transmission sensor node and the receiving side terminal. Herein, the network layer uses an IP address as a locator in order to search for a position of a receiving sensor node and transmit packets to the receiving side terminal, and the transport layer and the application layer use the IP address as an identifier (ID) in order to distinguish a communication session or a sensor node. That is, in the present Internet communication architecture, the IP address is commonly used as an identifier and a locator of a sensor node.

The IP address of the sensor node should not be changed while the sensor node establishes a communication session. However, in the current Internet communication architecture, although the identifier of the sensor node is not changed when the sensor node moves, the locator of the sensor node is changed whenever the sensor node moves. Accordingly, since the IP address, which is the locator of the sensor node, is changed as the sensor node moves, the communication session is not maintained, and the communication is stopped.

### DISCLOSURE OF INVENTION

### Technical Problem

Although the future Internet environment requires mobility and multi-homing, the present Internet communication architecture is inappropriate for the future Internet environment since an IP address is commonly used as an identifier and a locator of a device.

The present invention has been made to solve the problems involved in the IP architecture based on the TCP/IP hierarchical model as described above, and it is an object of the present invention to provide a method of supporting mobility of a device by separately managing the identifier and the locator of the device in a 6LoWPAN-based sensor network.

Another object of the present invention is to provide a method of supporting mobility of both a sensor node and a NEMO by separately managing the identifier and the locator of the device in a 6LoWPAN-based sensor network.

Still another object of the present invention is to provide a method of supporting mobility of a device, which is appropriate for a sensor network having limited calculation capability and energy source owing to a light-weighted mobility support architecture and a signaling minimized in a personal area network (PAN).

### Technical Solution

To achieve the above objects, in one aspect, the present invention provides a method of supporting mobility of a device in a sensor network based on Internet Protocol Version (IPv6), the method including the steps of: determining whether or not the device is an external device registered in a home mapping server and is moved to a personal area network (PAN) of the home mapping server; receiving, when an external device is moved to the personal area network of the home mapping server, a locator update request message containing an identifier and a locator of the external device from a gateway managing the personal area network; extracting the identifier of the device from the locator update request message, and transmitting, if the external device is an external device registered in the external mapping server), the identifier of the external device to the device management server, and requesting inquiry of a locator of the external mapping server, in which the external device is registered; transmitting a locator change request message to the external mapping server, the locator change request message requesting a change of the locator of the external device, which contains a locator of the gateway and the identifier of the external device and is mapped to the identifier of the external device, to a location of the gateway; and receiving a locator change response message as a result of changing the locator of the external device from the external mapping server in response to the locator change request message, and transmitting a locator update response message to the gateway.

Preferably, the sensor network based on the Internet Protocol Version is 6LoWPAN, and the external device is a sensor node or a mobile network (NEMO) including a plurality of sensor nodes connected to a mobile router MR.

Here, when the moved external device is registered in the home mapping server, the method of supporting mobility of a device further includes the steps of: receiving a locator update request message containing the identifier and the locator of the device from the gateway of the personal area network of the home mapping server to which the device has moved; extracting the identifier and the locator of the device from the locator update request message, and changing the locator of the device mapped to the identifier of the device to the location of the gateway of the personal area network of the home mapping server; and transmitting a locator update response message to the gateway of the personal area network of the home mapping server.

The device management server stores the identifier of the device and a locator of the home mapping server or the external mapping server in which the device are registered, and the external mapping server stores the identifier of the external device and the locator mapped to the external device identifier. When receiving the locator change request message, the external mapping server changes the locator of the external device mapped to the device identifier to the location of the gateway.

Preferably, a registration request message or a registration response message contains a dispatch header pattern field, a compressed header field, a mobility header dispatch field, and a data field. A pattern data informing the addition of mobility header dispatch is stored in the dispatch header pattern field, and an identification data for distinguishing a registration request message from a registration response message is stored in the mobility header dispatch field. In addition, a data field containing a data corresponding to the registration request message or the registration response message is added next to the mobility header dispatch field according to the identification data.

Further preferably, the dispatch header pattern field, the compressed header field, and the mobility header dispatch field are respectively 1-byte long, and the data field is 18-byte long in the case of the registration request message and 2-byte long in the case of the registration response message.

### Advantageous Effects

The method of supporting mobility of a device according to the present invention has a variety of effects described below compared with the prior art.

First, since the method of supporting mobility of a device according to the present invention separately manages an identifier and a locator of the device in a 6LoWPAN-based sensor network, mobility of the device is supported by changing only the locator of the device and maintaining the device identifier not to be changed when the device moves.

Second, the method of supporting mobility of a device according to the present invention supports mobility of both a sensor node and a NEMO in a 6LoWPAN-based sensor network.

Third, the method of supporting mobility of a device according to the present invention may be appropriately used for a sensor network having limited calculation capability and energy source owing to a light-weighted mobility support architecture and a signaling minimized in a personal area network (PAN).

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a view showing the TCP/IP hierarchical model;

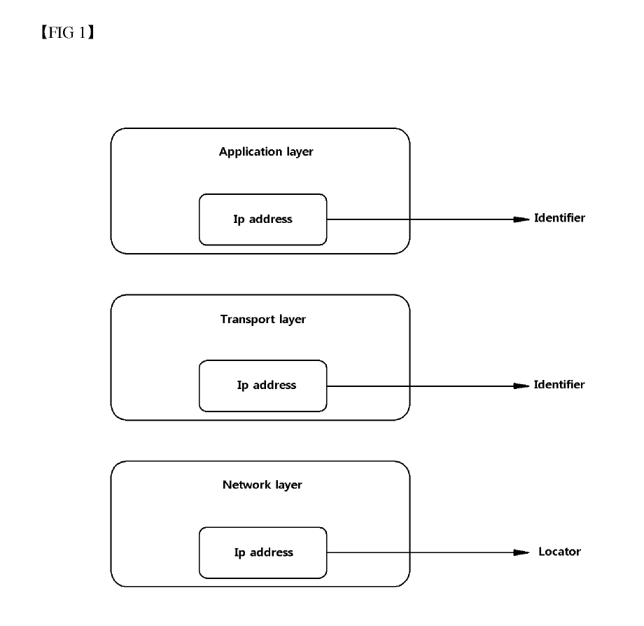

FIG. 2 is a view showing the concept of separately managing an identifier and a locator of a device;

FIG. 3 is a view showing a system for supporting mobility of a device based on the concept described in FIG. 2, according to an embodiment of the present invention;

FIG. 4 is a view illustrating a message transmitted and received in a system for supporting mobility of a device according to an embodiment of the present invention;

FIG. 5 is a view illustrating an example of a registration request message and a registration response message according to the present invention;

FIG. 6 is a view further specifically illustrating an example of a dispatch header pattern and a compressed header pattern of a 6LoWPAN IP header according to the present invention;

FIG. 7 is a view further specifically illustrating an example of mobility header dispatch and a data field of a 6LoWPAN IP header according to the present invention;

FIG. 8 is a view illustrating an example of a method of supporting mobility of a device according to the present invention;

FIG. 9 is a view illustrating an example of an identifier and a locator of a device registered in a device management server and a home mapping server in an example of a method of supporting mobility of a device according to the present invention;

FIG. 10 is a view illustrating another example of a method of supporting mobility of a device according to the present invention;

FIG. 11 is a view illustrating an example of an identifier and a locator of a device registered in a device management server in another example of a method of supporting mobility of a device according to the present invention;

FIG. 12 is a view illustrating an example of an identifier and a locator of a device registered in a home mapping server in another example of a method of supporting mobility of a device according to the present invention;

FIG. 13 is a view illustrating an example of an identifier and a locator of a device registered in an external mapping server in another example of a method of supporting mobility of a device according to the present invention;

FIG. 14 is a view illustrating still another example of a method of supporting mobility of a device according to the present invention;

FIG. 15 is a view illustrating an example of an identifier and a locator of a device registered in a device management server in still another example of a method of supporting mobility of a device according to the present invention;

FIG. 16 is a view illustrating an example of an identifier and a locator of a device registered in a home mapping server in still another example of a method of supporting mobility of a device according to the present invention;

FIG. 17 is a view illustrating an example of an identifier and a locator of a device registered in an external mapping server in still another example of a method of supporting mobility of a device according to the present invention;

FIG. 18 is a view illustrating an example of establishing a communication session with a counterpart device communicating with an external device, after the external device moves to a personal area network of a home mapping server, according to present invention; and

FIG. 19 is a view illustrating an example of establishing a communication session with a counterpart device with which it is desired for an external device to communicate, after the external device moves to a personal area network of a home mapping server, according to present invention.

### BEST MODE FOR CARRYING OUT THE INVENTION

Hereinafter, a method of supporting mobility of a device according to the present invention will be described in more detail with reference to the accompanying drawings.

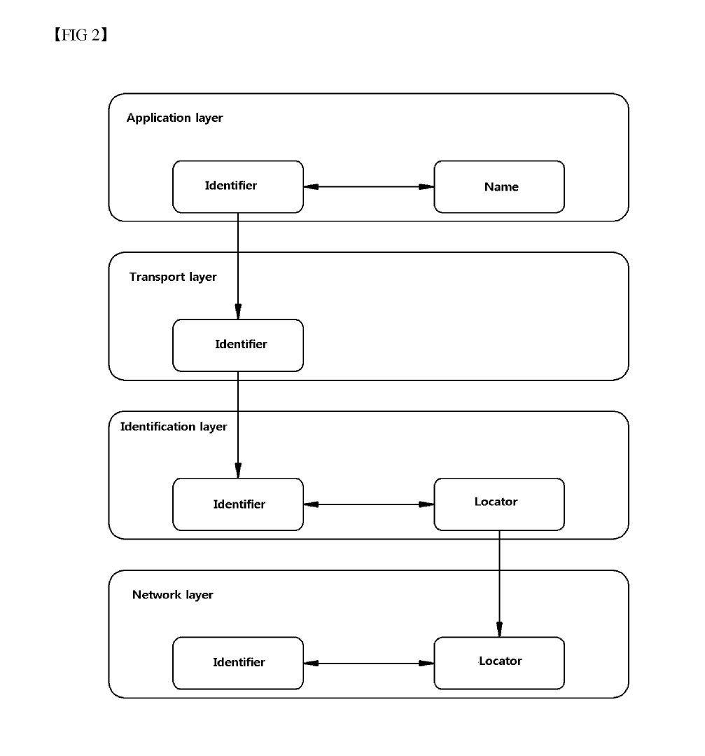

FIG. 2 is a view showing the concept of separately managing an identifier and a locator of a device.

Referring to FIG. 2, the proposed hierarchical model is a hierarchical model separately using an identifier and a locator of a device by disposing an additional identification layer between the transport layer and the network layer and mapping the device identifier to the locator of the device through the identification layer. That is, when the device moves, only the locator of the device is changed while the identifier of the device is unchanged, and the identification layer maps the changed locator of the device to the device identifier.

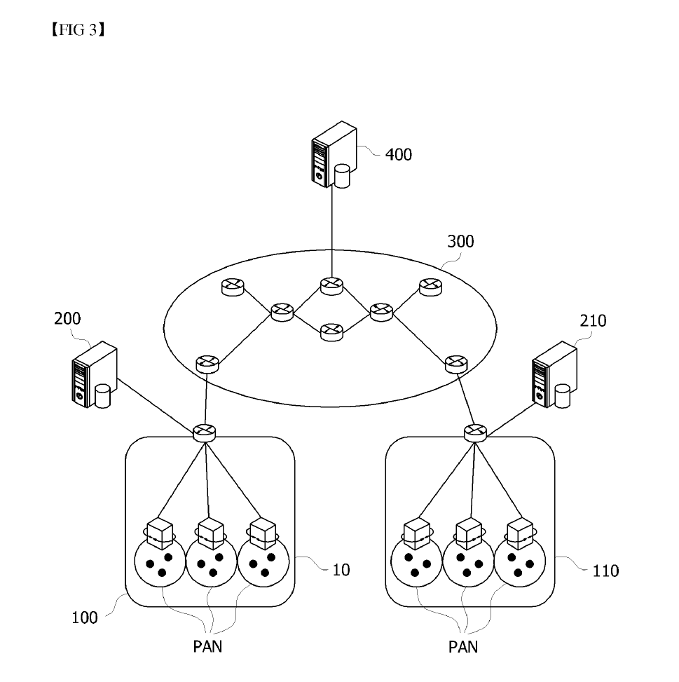

FIG. 3 is a view showing a system for supporting mobility of a device based on the concept described in FIG. 2, according to an embodiment of the present invention.

Referring to FIG. 3, a plurality of devices is connected to each of a plurality of gateways 10, and a network including a gateway and a plurality of devices is referred to as a personal area network. A plurality of personal area networks belonging to a group is referred to as a domain 100 or 110.

The domain 100 or 110 is connected to a mapping server 200 or 210 and a device management server 400 through an Internet network 300. A domain is a unit of sensor network managed by an independent mapping server, and the domain 100 is managed by the mapping server 200, whereas the domain 110 is managed by the mapping server 210. A device positioned in the domain 100 is connected to an adjacent gateway and registered in the mapping server 200 through the connected gateway. In the same manner, a device positioned in the domain 110 is connected to an adjacent gateway and registered in the mapping server 210 through the connected gateway.

The device management server 400 stores the identifier and the name of a device registered in a mapping server and the home mapping server locator of the device, and the identifier and the locator of a device positioned in a domain 100 or 110 managed by each mapping server are registered and stored in the mapping server 200 or 210.

The mapping server 200 which registers and stores the identifier and the locator of a device positioned in the domain 100 and manages identifier-to-locator information of the device positioned in the domain 100 is referred to as a home mapping server of the device positioned in the domain 100. Meanwhile, the mapping server 210 which registers and stores the identifier and the locator of a device positioned in the domain 110 and manages identifier-to-locator information of the device positioned in the domain 110 is referred to as a home mapping server of the device positioned in the domain 110. The mapping server 200 becomes an external mapping server for a device positioned in the domain 110, and the mapping server 210 becomes an external mapping server for a device positioned in the domain 100.

When a device moves to a personal area network of an external mapping server, the external mapping server registers and stores the identifier and the locator of the moved device in the external mapping server, and only the locator is changed from the gateway of a personal area network connected to the device before the movement to the gateway of a personal area network connected to the device after the movement without changing the identifier of the moved device. The external mapping server inquires the locator of the home mapping server of the moved device from the device management server 400 based on the identifier of the moved device and informs the home mapping server of the moved device of the changed locator of the device. The home mapping server updates only the locator with the gateway of the personal area network, to which the device has moved and connected, without changing the identifier of the moved device.

Here, the device is defined as a sensor node or a mobile network MR in which a plurality of sensor nodes is connected to a mobile router, and this is the same in the following description.

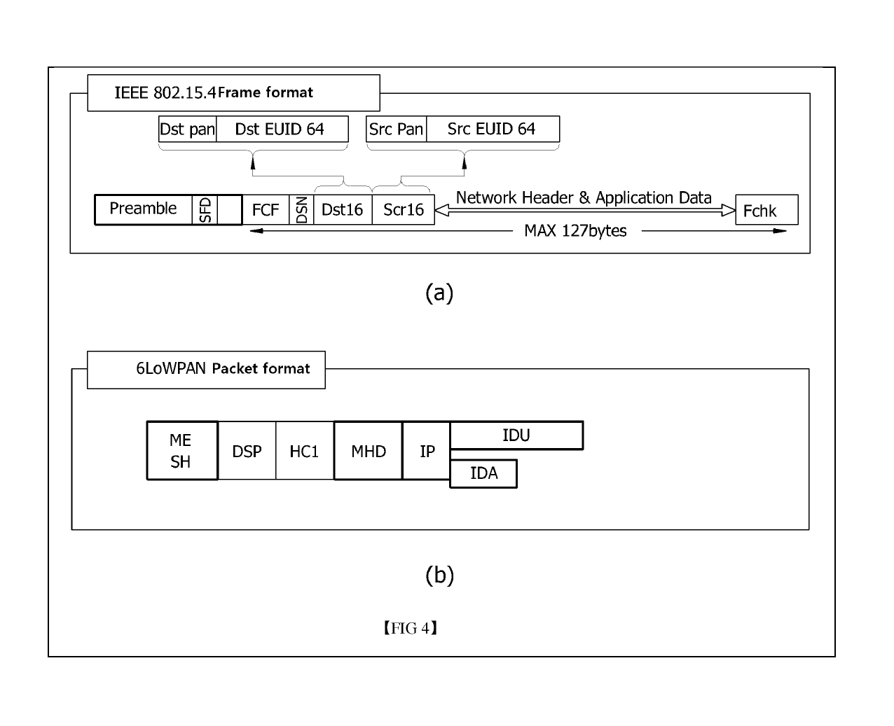

FIG. 4 is a view illustrating a message transmitted and received in a system for supporting mobility of a device according to an embodiment of the present invention.

Referring to FIG. 4, when a device positioned in a personal area network (PAN) moves to a new personal area network (PAN), the device determines that it has moved to the new personal area network by comparing the PAN ID of a beacon message received from the new personal area network with the PAN ID of a beacon message received from the previous personal area network. Then, the device transmits a connection request message for connecting to the new personal area network in a broadcasting method. Here, when the device moved to the new personal area network is a sensor node, the sensor node creates and transmits the connection request message, and when the device moved to the new personal area network is a mobile network, only the mobile router of the mobile network creates and transmits the connection request message.

The gateway of the new personal area network receiving the connection request message allocates a 16-bit address unique within the new personal area network to the device and transmits a connection response message containing the allocated 16-bit address to the device in response to the connection request message. Here, when the device is a sensor node, a 16-bit address unique to the sensor node is allocated, and when the device is a mobile network, a 16-bit address unique only to the mobile router is allocated.

Then, the device transmits a registration request message containing a 128-bit device identifier to register itself in the gateway of the new personal area network, and the gateway transmits a locator update request message containing the identifier and the locator of the device to the home mapping server to update the locator of the device in response to the registration request message. Here, when the device is a sensor node, the sensor node creates and transmits the registration request message, and when the device is a mobile network, only the mobile router creates and transmits the registration request message in order to register the mobile network in the new personal area network. The home mapping server determines whether or not the device moved into the new personal area network is a device registered in the home mapping server based on the device identifier. When the moved device is registered in the home mapping server, the home mapping server changes the locator of the moved device to the gateway of the new personal area network to which the device has moved and transmits a locator update response message to the gateway of the new personal area network. When the gateway of the new personal area network receives the locator update response message, it transmit a registration response message to the moved device to change only the locator to the gateway of the personal area network, to which the device is currently connected, without changing the identifier of the moved device.

However, if the identifier of the moved device is not registered in the home mapping server, the home mapping server transmits an inquiry request message requesting inquiry of the locator of the home mapping server, i.e., an external mapping server, of the device, in which the device is registered, to the device management server based on the device identifier, and the device management server transmits an inquiry response message containing the locator of the external mapping server, in which the device is registered, to the home mapping server in response to the inquiry request message.

The home mapping server transmits a locator change request message for changing the locator of the device to the gateway of the new personal area network to the location of the external mapping server contained in the inquiry response message, and the external mapping server changes the locator of the device to the gateway of the new personal area network and creates and transmits a locator change response message to the home mapping server in response to the locator change request message.

The home mapping server receiving the locator change response message creates and transmit a locator update response message to the gateway, and the gateway receiving the locator update response message transmits a registration response message to the device. In this manner, only the locator of the device may be changed to the gateway of the personal area network, to which the device is currently connected, without changing the identifier.

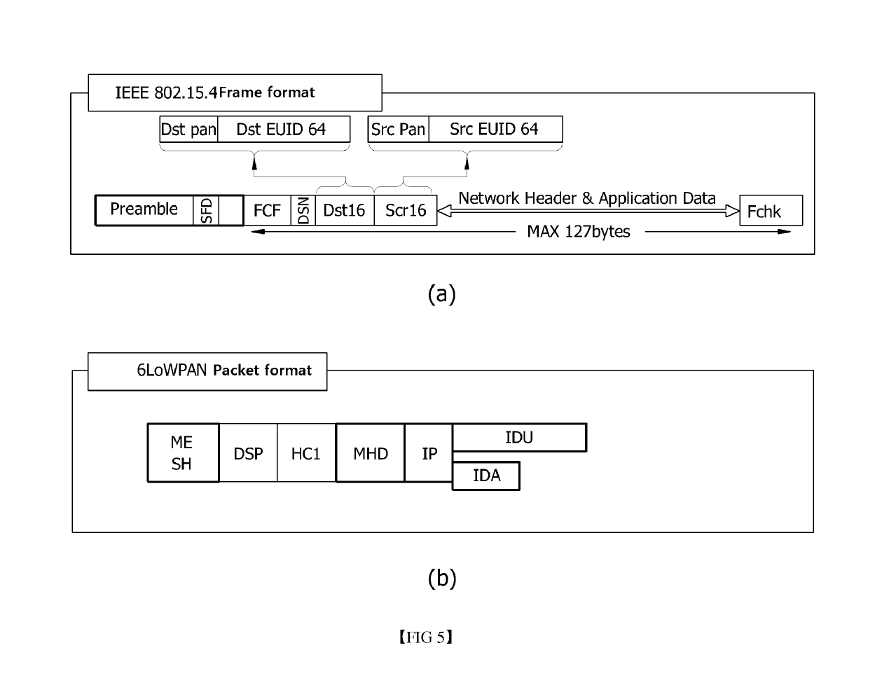

FIG. 5 is a view illustrating an example of a registration request message and a registration response message according to the present invention.

FIG. 5(a) is a view showing the entire frame format of the registration request message or the registration response message when a 6LoWPAN packet is contained in the IEEE 802.15.4 frame, the maximum frame size of which is 127 bytes.

Meanwhile, the 6LoWPAN packet format contained in the network header part will be described hereinafter in detail with reference to FIG. 5(b). The 6LoWPAN packet contains a mesh header MESH, a 6LoWPAN IP header and a data field corresponding to the registration request message IDU or the registration response message IDA. Here, the mesh header is a header indicating information for mesh routing, and the 6LoWPAN IP header is a header containing a dispatch header pattern DSP, a compressed header pattern HC1 and a mobility header dispatch pattern MHD and indicating information on the registration request message or the registration response message. The dispatch header is a header indicating information on the subsequently positioned headers, and a compressed header indicates compressed information of an IP header (in the case of HC1) or a UDP header (in the case of HC2). That is, the IP header is compressed to the maximum by the HC1 header dispatch, and the UDP header is compressed to the maximum by the HC2 header dispatch.

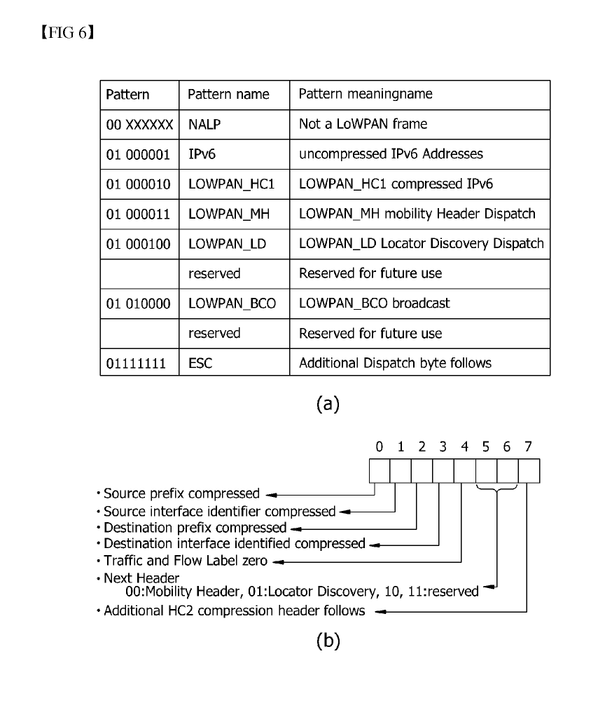

FIG. 6 is a view further specifically illustrating an example of a dispatch header pattern and a compressed header pattern of a 6LoWPAN IP header according to the present invention.

The dispatch header pattern of the 6LoWPAN IP header will be described hereinafter in further detail with reference to FIG. 6(a).

The dispatch header is 1-byte long, and “01000011” is defined as mobility header dispatch indicating a registration request message or a registration response message. Mobility header dispatch of a variety of patterns can be used according to the application field of the present invention, and this is within the scope of the present invention.

The compressed header pattern HC1 of the 6LoWPAN IP header will be described hereinafter in further detail with reference to FIG. 6(b).

The compressed header is 1-byte long, and the first bit is a source prefix compressed bit, the second bit is a source interface identifier compressed bit, the third bit is a destination prefix compressed bit, the fourth bit is a destination interface identifier compressed bit, the fifth bit is a traffic and flow label zero bit, the sixth and seventh bits are mobility header dispatch bits, and the eighth bit is a HC2 compression header bit. For example, when ‘00’ is filled in the sixth and seventh bits, this means the mobility header dispatch, and other data bits may be used to express the mobility header dispatch according to the application field of the present invention.

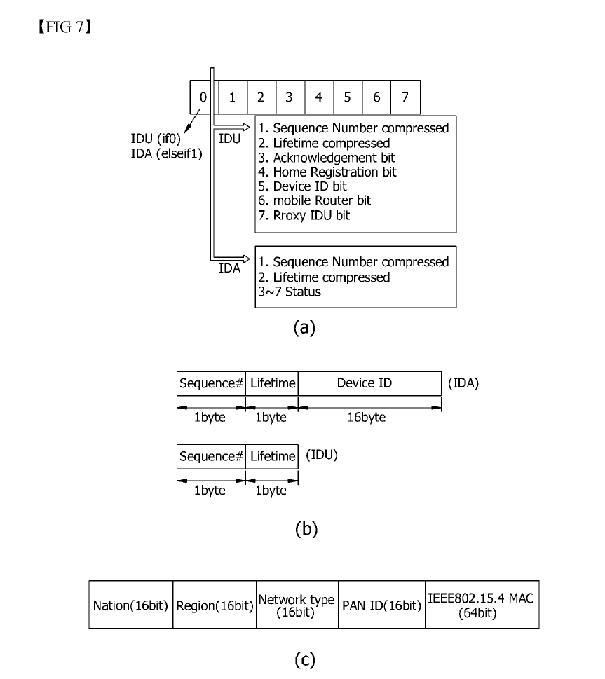

FIG. 7 is a view further specifically illustrating an example of mobility header dispatch and a data field of a 6LoWPAN IP header according to the present invention.

The mobility header dispatch of the 6LoWPAN IP header will be described hereinafter in further detail with reference to FIG. 7(a).

The mobility header dispatch is 1-byte long, and an identifier bit of a registration request message or a registration response message is recorded in the first bit. For example, when a value of 0 is recorded, it means a registration request message, and when a value of 1 is recorded, it means a registration response message. When a value indicating a registration request message is recorded in the identifier bit, the second bit is a sequence number bit, the third bit is a lifetime bit, the fourth bit is an approval request bit, the fifth bit is a bit requesting update of the locator of the mapping server, the sixth bit is a bit indicating that the device is a sensor node, the seventh bit is a bit indicating that the device is a mobile router, and the eighth bit is a bit indicating that the device is a mobile router if the device moves to a mobile network.

Meanwhile, when a value indicating a registration response message is recorded in the identifier bit, the second bit is a sequence number bit, the third bit is a lifetime bit and the fourth to eighth bits are bits indicating a status.

Referring to FIG. 7(b), the data field corresponding to the registration request message contains one byte of sequence number field, one byte of lifetime field and 16 bytes of device identifier field, and the data field corresponding to the registration response message contains one byte of sequence number field and one byte of lifetime field. As shown in FIG. 7(c), the 16-byte device identifier field includes two bytes of country specific data field, two bytes of region specific data field, two bytes of network specific data field, two bytes of personal area network identification data field, and eight bytes of IEEE 802.15.4 MAC address data field.

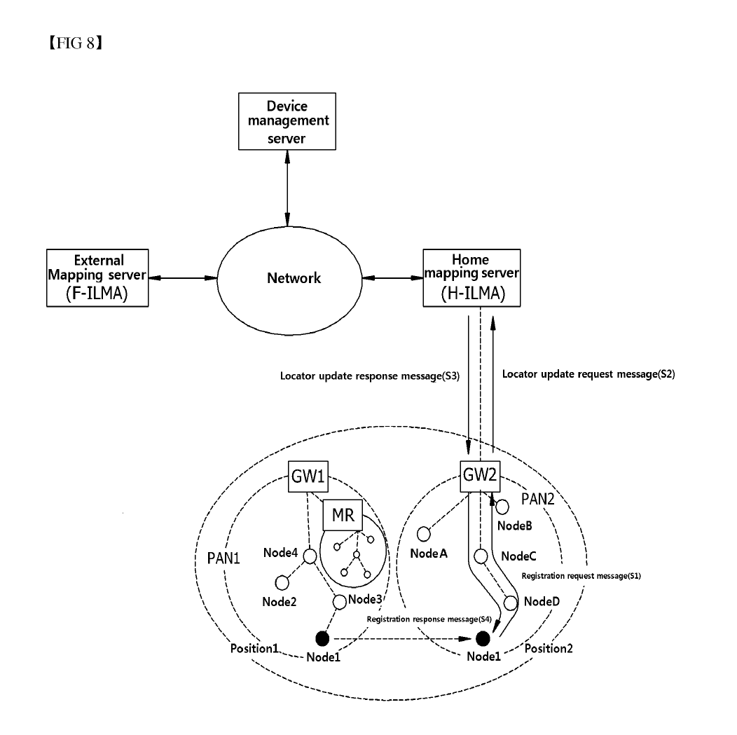

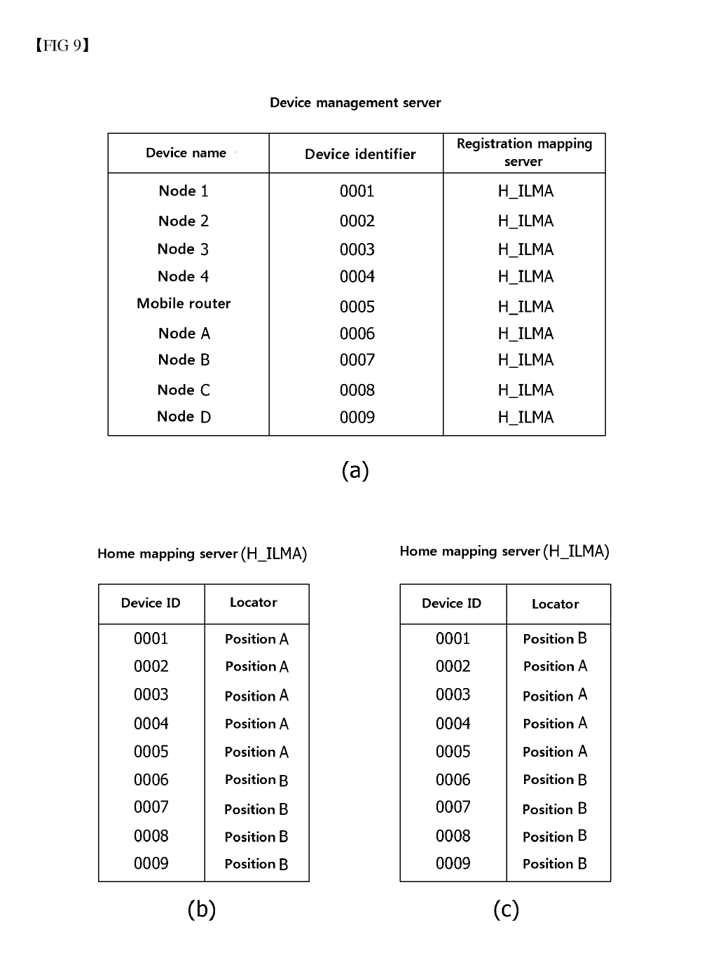

FIG. 8 is a view illustrating an example of a method of supporting mobility of a device according to the present invention, and FIG. 9 is a view illustrating an example of an identifier and a locator of a device registered in a device management server and a home mapping server in an example of a method of supporting mobility of a device according to the present invention.

Referring to FIGS. 8 and 9, when the sensor node 1 among the devices positioned in the personal area network PAN1 of the home mapping server H-ILMA moves to the personal area network PAN2 of the home mapping server H-ILMA, the sensor node 1 recognizes that the sensor node 1 has moved to the new personal area network PAN2 based on a beacon message received from the personal area network PAN2 and connects to the gateway GW2 of the new personal area network PAN2 through a connection request message and a connection response message.

After connecting to the new personal area network PAN2, the sensor node 1 creates a registration request message containing the identifier of the sensor node 1 and transmits the registration request message to the gateway GW2 S1. A pattern data indicating mobility header dispatch is recorded in the dispatch header pattern of the registration request message, and a data indicating mobility header is recorded in the sixth and seventh bits of the compressed header. A data bit indicating a registration request message is recorded in the first bit of the mobility header, a data bit indicating a sequence number of the registration request message is recorded in the second bit, a data bit indicating lifetime of the registration request message is recorded in the third bit, a data bit indicating request for approval of the registration request message is recorded in the fourth bit, a data bit requesting registration of the sensor node 1 in the mapping server is recorded in the fifth bit, and a data bit indicating that the sensor node has created the registration request message is recorded in the sixth bit. Since the sensor node 1 creates and transmits the registration request message when the sensor node 1 moves to the new personal area network PAN2, a data bit opposite to the sixth bit is recorded in the seventh and eighth bits.

After receiving the registration request message, the gateway GW2 creates a locator update request message containing the identifier and the locator of the sensor node 1 and transmits the created locator update request message to the home mapping server H-ILMA S2. Here, the locator of the sensor node 1 is the location of the gateway GW2. The home mapping server determines that the sensor node 1 is a device registered in the home mapping server based on the identifier of the sensor node 1 and changes the locator of the sensor node 1 registered in the home mapping server to the location of the gateway GW2 based on the locator of the sensor node 1. After changing the locator of the sensor node 1, the home mapping server creates and transmits a locator update completion message to the gateway GW2 S3, and the gateway GW2 receiving the locator update completion message creates and transmits a registration response message to the sensor node 1 S4.

FIG. 9(a) is a view showing an example of a device name, a device identifier and a locator of a registration mapping server registered in the device management server, FIG. 9(b) is a view showing an example of a locator registered in the home mapping server before the sensor node 1 moves to a new personal area network PAN2, and FIG. 9(c) is a view showing an example of a locator registered in the home mapping server after the sensor node 1 moves to the new personal area network PAN2. As shown in FIGS. 9(b) and 9(c), although the sensor node 1 moves to the new personal area network PAN2, only the locator of the sensor node 1 is changed from position A to position B, and the identifier of the sensor node 1 is not changed.

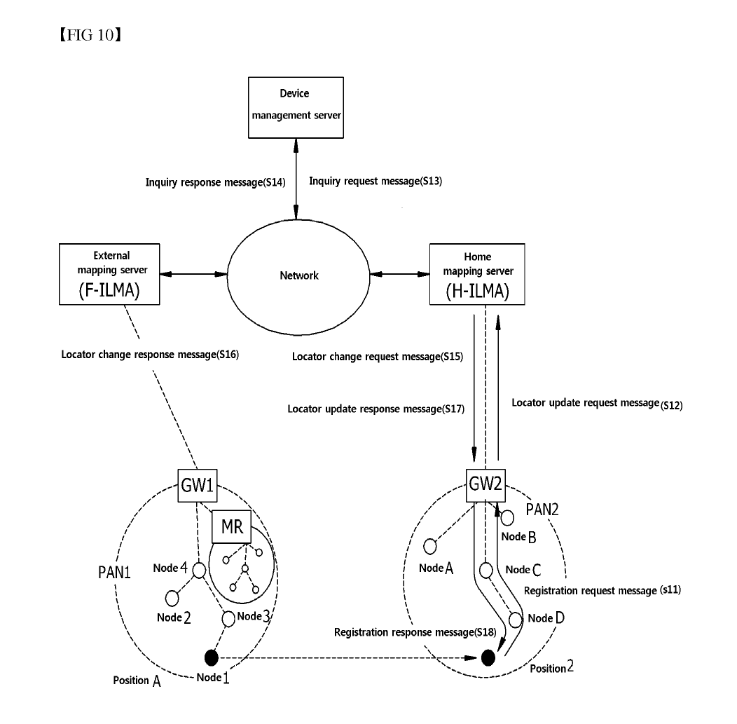

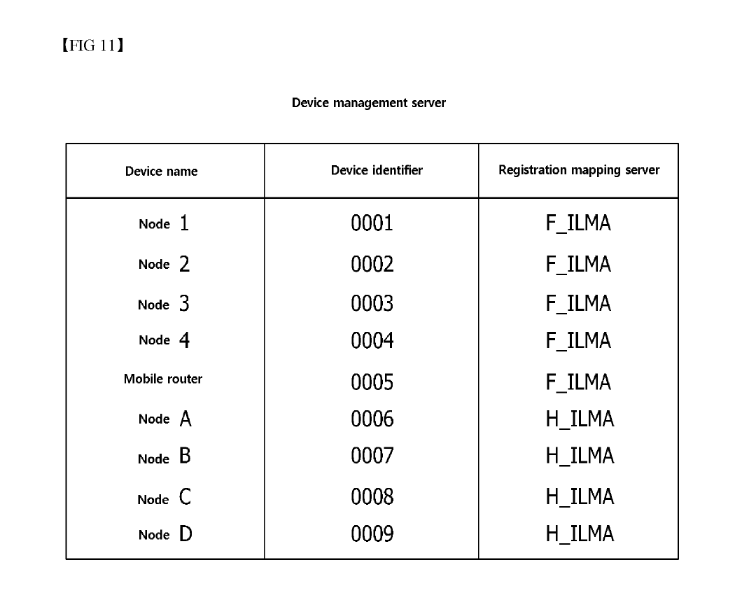

FIG. 10 is a view illustrating another example of a method of supporting mobility of a device according to the present invention, and FIGS. 11, 12 and 13 are views respectively illustrating an example of an identifier and a locator of a device registered in a device management server, a home mapping server or an external mapping server in another example of a method of supporting mobility of a device according to the present invention.

Referring to FIG. 10, when the sensor node 1 among the devices positioned in the personal area network PAN1 of the external mapping server F-ILMA moves to the personal area network PAN2 of the home mapping server H-ILMA, the sensor node 1 recognizes that the sensor node 1 has moved to the new personal area network PAN2 based on a beacon message received from the personal area network PAN2 and connects to the gateway GW2 of the new personal area network PAN2 through a connection request message and a connection response message.

After connecting to the new personal area network PAN2, the sensor node 1 creates a registration request message containing the identifier of the sensor node 1 and transmits the registration request message to the gateway GW2 S11. After receiving the registration request message, the gateway GW2 creates a locator update request message containing the identifier and the locator of the sensor node 1 and transmits the created locator update request message to the home mapping server H-ILMA S12. Here, the locator of the sensor node 1 is the location of the gateway GW2. The home mapping server determines whether or not the registration mapping server of the sensor node 1 is the home mapping server based on the identifier of the sensor node 1. If the registration mapping server of the sensor node 1 is the home mapping server based on a result of the determination, the locator of the sensor node is changed and registered in the home mapping server.

However, if the sensor node 1 is not registered in the home mapping server, the identifier and the locator of the sensor node 1 are registered and stored in the home mapping server. Then, the home mapping server transmits an inquiry request message requesting inquiry of the locator of the external mapping server, in which the sensor node 1 is registered, to the device management server S13. The device management server transmits an inquiry response message containing the locator of the external mapping server mapped to the identifier of the sensor node 1 to the home mapping server in response to the inquiry request message S14.

The home mapping server transmits a locator change request message containing the identifier and the changed locator of the sensor node 1 to the external mapping server S15, and the external mapping server updates the registered locator of the sensor node 1 with the changed locator, i.e., the locator of the gateway GW2, based on the locator change request message and transmits a locator change response message to the home mapping server S16. After receiving the locator change response message, the home mapping server transmits a locator update response message informing that the position of the sensor node 1 has been changed to the gateway GW2 S17. After receiving the locator update response message, the gateway GW2 transmits a registration response message to the sensor node 1 to inform the sensor node 1 that the locator of the sensor node 1 is changed S18.

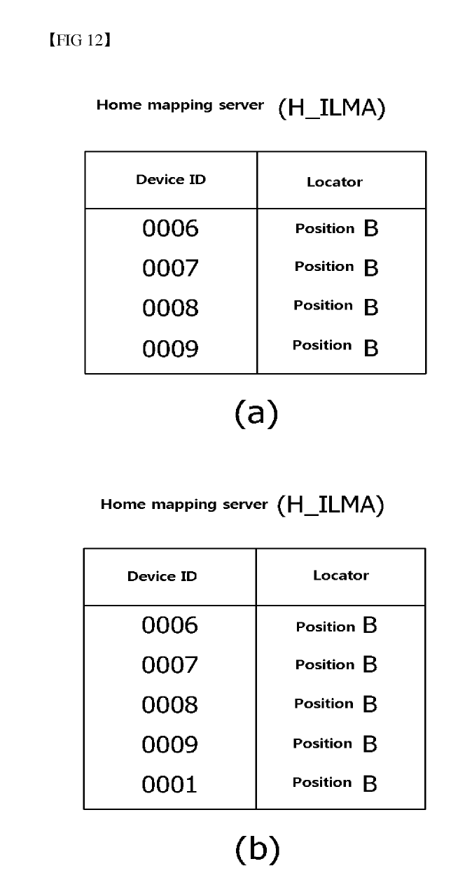

FIG. 12(a) is a view showing an example of a locator of a device registered in the home mapping server before the sensor node 1 moves to a new personal area network PAN2, and FIG. 12(b) is a view showing an example of a locator of a device registered in the home mapping server after the sensor node 1 moves to the new personal area network PAN2.

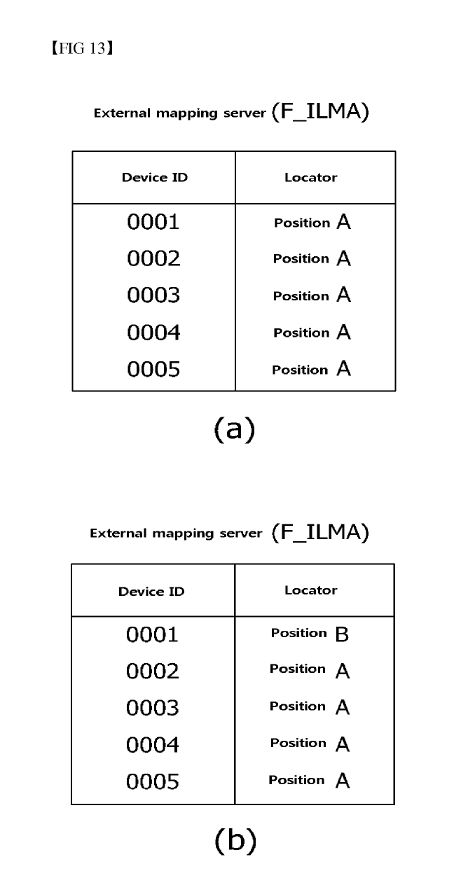

FIG. 13(a) is a view showing an example of a locator of a device registered in the external mapping server before the sensor node 1 moves to a new personal area network PAN2, and FIG. 13(b) is a view showing an example of a locator of a device registered in the external mapping server after the sensor node 1 moves to the new personal area network PAN2. As shown in FIGS. 13(a) and 13(b), when the external mapping server receives a locator update request message from the home mapping server, the external mapping server in which the sensor node 1 is registered updates the locator of the sensor node 1 from position A to position B.

As shown in FIGS. 12 and 13, even when the sensor node 1 moves to a new external mapping server from the home mapping server of the sensor node 1, although the locator of the sensor node 1 is changed from position A to position B, the identifier of the sensor node 1 is not changed.

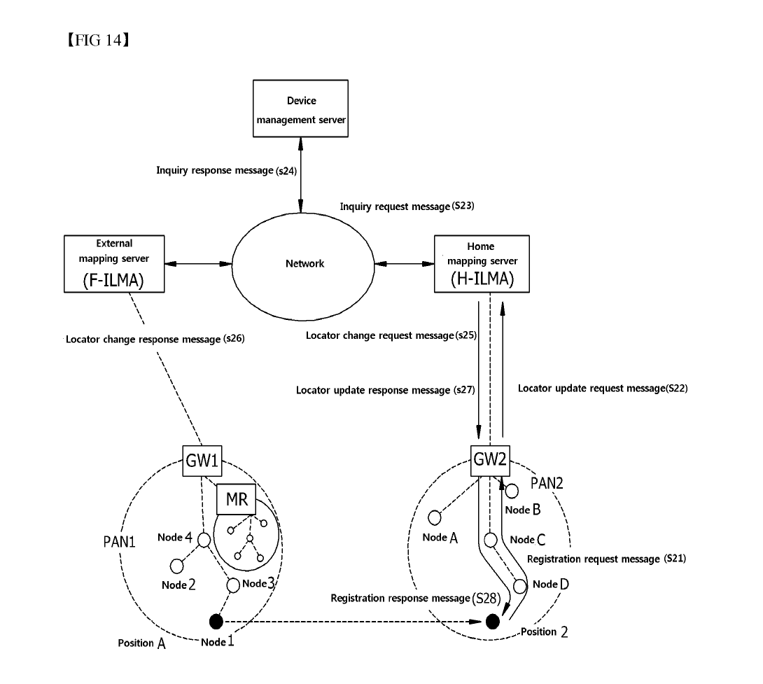

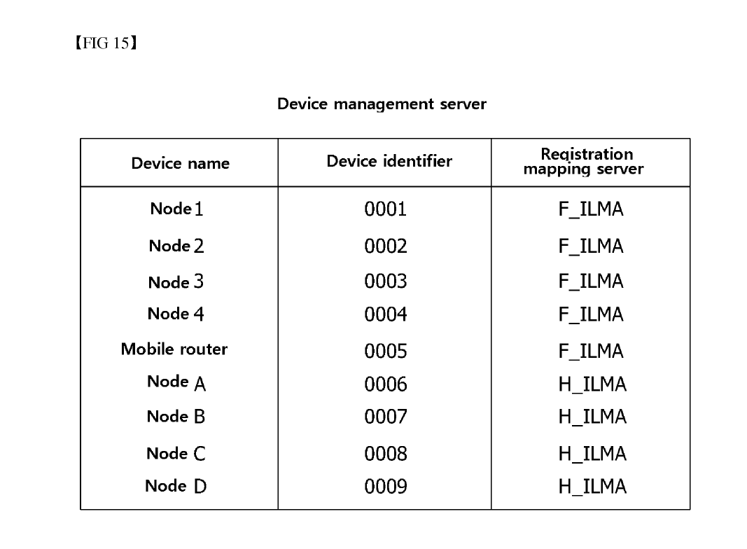

FIG. 14 is a view illustrating still another example of a method of supporting mobility of a device according to the present invention, and FIGS. 15, 16 and 17 are views respectively illustrating an example of an identifier and a locator of a device registered in a device management server, a home mapping server or an external mapping server in still another example of a method of supporting mobility of a device according to the present invention.

Referring to FIG. 14, when a mobile network NEMO among the devices positioned in the personal area network PAN1 of the external mapping server F-ILMA moves to the personal area network PAN2 of the home mapping server H-ILMA, the mobile router MR of the mobile network recognizes that the mobile network has moved to the new personal area network PAN2 based on a beacon message received from the personal area network PAN2 and connects to the gateway GW2 of the new personal area network PAN2 through a connection request message and a connection response message.

After connecting to the new personal area network PAN2, the mobile router MR creates a registration request message containing the identifier of the mobile router and transmits the registration request message to the gateway GW2 S21. After receiving the registration request message, the gateway GW2 creates a locator update request message containing the identifier and the locator of the mobile router MR and transmits the created locator update request message to the home mapping server H-ILMA S22. Here, the locator of the mobile router MR is the location of the gateway GW2. The home mapping server stores the identifier and the locator of the mobile router MR in the home mapping server based on the identifier and the locator of the mobile router MR and determines the mobile router MR is a device registered in the home mapping server based on the identifier of the mobile router MR. If the mobile router MR is a device that is not registered in the home mapping server, the mobile router MR transmits an inquiry request message requesting inquiry of the locator of the external mapping server, in which the mobile router MR is registered, to the device management server S23. The device management server transmits an inquiry response message containing the locator of the external mapping server mapped to the identifier of the mobile router MR to the home mapping server in response to the inquiry request message S24.

The home mapping server transmits a locator change request message containing the identifier and the changed locator of the mobile router MR to the external mapping server S25, and the external mapping server updates the registered locator of the mobile router MR with the changed locator, i.e., the locator of the gateway GW2, and transmits a locator change response message to the home mapping server S26. After receiving the locator change response message, the home mapping server transmits a locator update response message informing that the position of the mobile router MR has been changed to the gateway GW2 S27. After receiving the locator update response message, the gateway GW2 transmits a registration response message to the mobile router MR to inform the mobile router MR that the locator of the mobile router MR is changed S28.

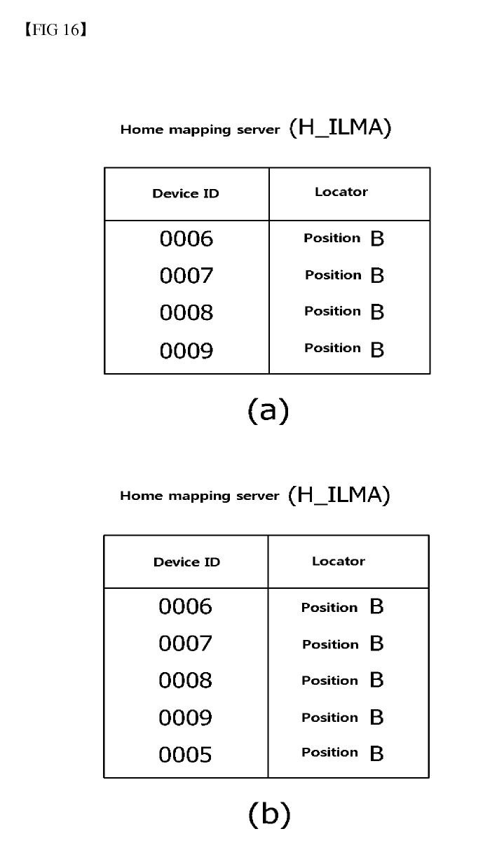

FIG. 16(a) is a view showing an example of a locator registered in the home mapping server before the mobile router MR moves to a new personal area network PAN2, and FIG. 16(b) is a view showing an example of a locator registered in the home mapping server after the mobile router MR moves to the new personal area network PAN2. As shown in FIGS. 16(a) and 16(b), when the locator update request message is received from the gateway GW2 of the personal area network PAN2 to which the mobile router MR has moved, the locator of the mobile router MR is registered in the home mapping server.

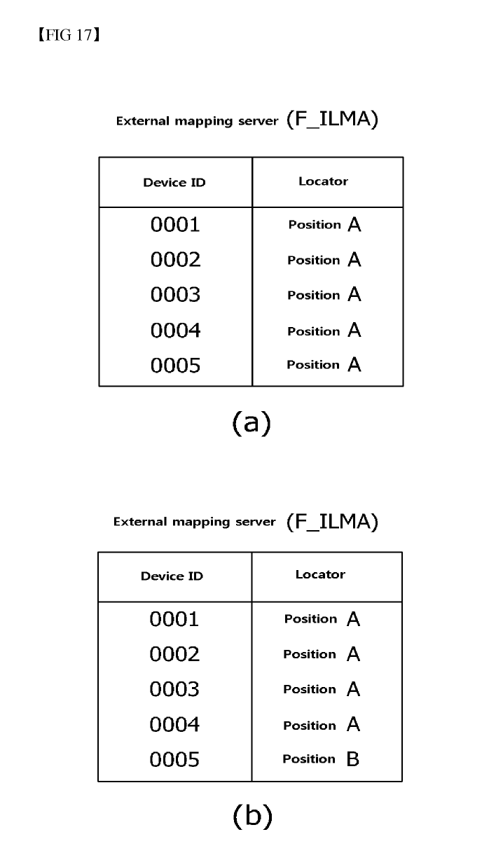

FIG. 17(a) is a view showing an example of a locator registered in the external mapping server before the mobile router MR moves to a new personal area network PAN2, and FIG. 17(b) is a view showing an example of a locator registered in the external mapping server after the mobile router MR moves to the new personal area network PAN2. As shown in FIGS. 17(a) and 17(b), when the locator update request message is received from the home mapping server, the external mapping server in which the mobile router MR is registered updates the locator of the mobile router MR from position A to position B.

As shown in FIGS. 16 and 17, even when the mobile network moves to a new external mapping server from the home mapping server of the mobile network, although the locator of the mobile network is changed from position A to position B, the identifier of the mobile router is not changed.

The method of managing mobility of a device according to an embodiment of the present invention described with reference to FIGS. 8, 10 and 14 is a method of supporting mobility of a device based on a network, in which a sensor node or a mobile network itself does not update and register a changed locator in the home mapping server, but the gateway of a personal area network to which the sensor node or the mobile network has moved updates and registers the locator in the home mapping server instead. That is, if a sensor node or a mobile network transmits a registration request message only to the gateway of a personal area network to which the sensor node or the mobile network has moved, the gateway and the mapping server which manages the gateway update the changed locator of the sensor node or the mobile network and change the locator of the sensor node or the mobile network registered in the home mapping server of the sensor node or the mobile network.

In the present invention, when a device moves, since only the locator of the device is changed to the location of the gateway of a personal area network, to which the device has moved, without changing the device identifier, mobility of the device is easily supported. Furthermore, in the present invention, since it is not that the moved device changes the locator by itself, but the locator is changed based on a network, mobility of a device can be effectively supported in a sensor network having a limited energy source and calculation capability.

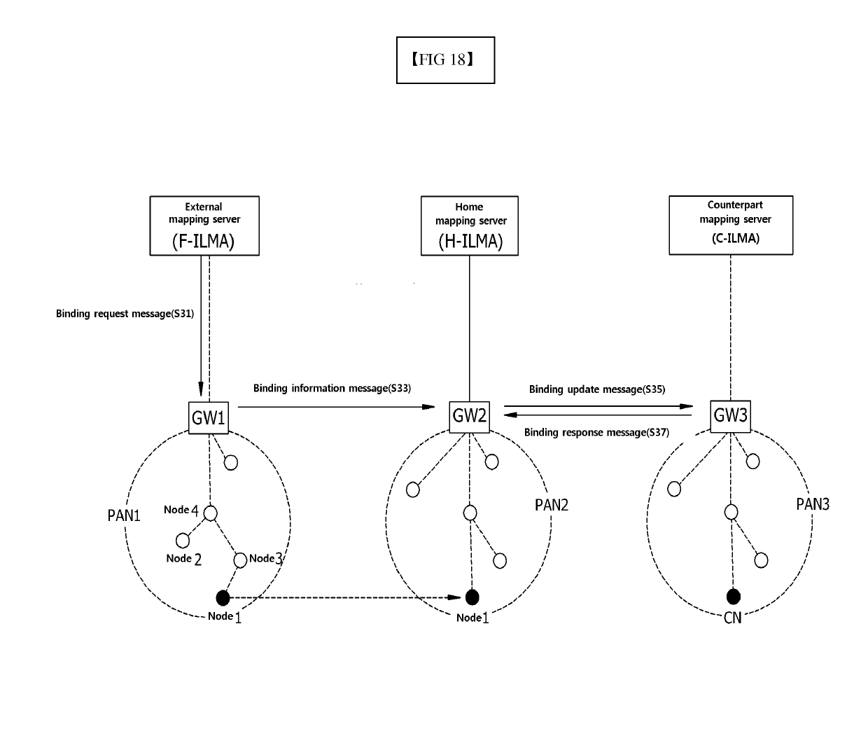

FIG. 18 is a view illustrating an example of establishing a communication session with a counterpart device communicating with an external device, after the external device moves to a personal area network of a home mapping server, according to present invention.

Referring to FIG. 18, when an external device (node 1) registered in the external mapping server F-ILMA moves to a personal area network of the home mapping server H-ILMA and connects to the gateway GW2 of the home mapping server while communicating with a counterpart device CN registered in the counterpart mapping server C-ILMA, the external mapping server transmits a binding request message to the gateway GW1 of the external mapping server to which the external device is connected before moving to the gateway of the home mapping server S31. The gateway GW1 transmits a binding information message containing information on the locator of the gateway GW3, to which the counterpart device communicating with the external device is connected, to the gateway GW2 to which the external device is moved and connected, in response to the binding request message S33. The gateway GW2 transmits a binding update request message, which contains the locator of the gateway GW2 and requests update of binding information, to the gateway GW3 to which the counterpart device is connected S35. The gateway GW3 receiving the binding update request message updates the binding information between the external device and the counterpart device and transmits a binding update response message to the gateway GW2 in response to the binding update request message.

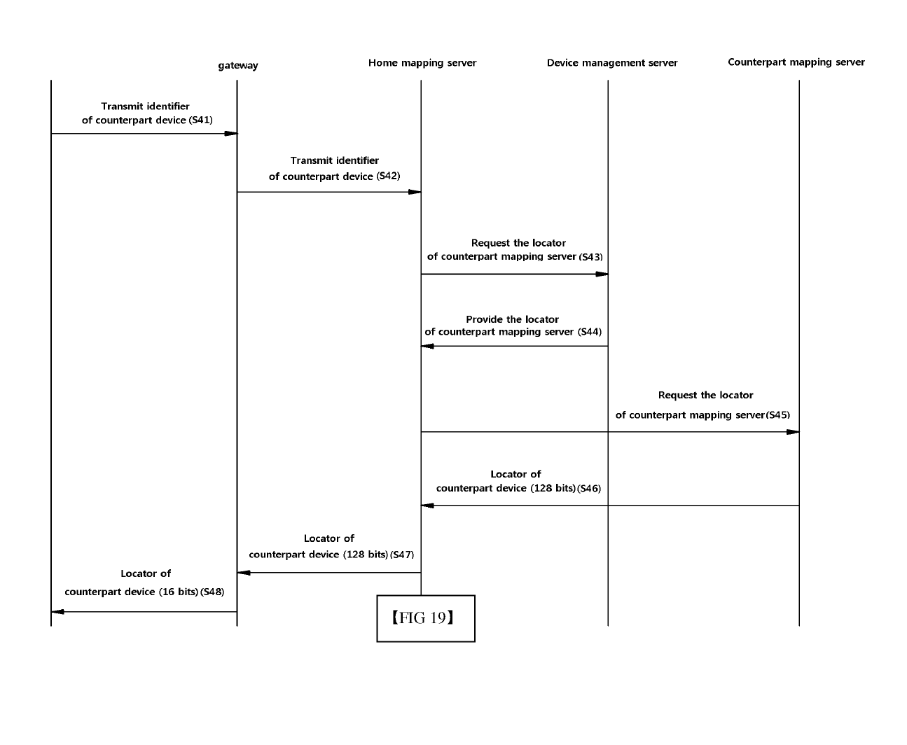

FIG. 19 is a view illustrating an example of establishing a communication session with a counterpart device with which it is desired for an external device to communicate, after the external device moves to a personal area network of a home mapping server, according to present invention.

Referring to FIGS. 18 and 19, after an external device (node 1) registered in the external mapping server F-ILMA moves to a personal area network of the home mapping server H-ILMA and connects to the gateway GW2 of the home mapping server, the external device transmits the identifier of a counterpart device with which it is desired for an external device to communicate, to the gateway GW2 of the home mapping server S41. The gateway GW2 transmits the receive identifier of the counterpart device to the home mapping server S42, and the home mapping server requests the locator of the counterpart mapping server C-ILMA, in which the counterpart device is registered, by transmitting the identifier of the counterpart device to the device management server S43. The device management server provides the home mapping server with the locator of the counterpart mapping server S44, and the home mapping server requests the locator of the counterpart device (locator of GW2) from the counterpart mapping server based on the locator of the counterpart mapping server S45. The counterpart mapping server transmits the locator of the counterpart device to the home mapping server S46, and the home mapping server transmits the received locator of the counterpart device to the gateway GW2 of the home mapping server S47. The gateway GW2 of the home mapping server transmits the locator of the counterpart device to the external device, and the external device established a communication session between the external device and the counterpart device based on the received locator of the counterpart device S48. Here, the locator of the counterpart device transmitted to the home mapping server and the locator of the counterpart device transmitted to the gateway of the home mapping server in steps S46 and S47 are respectively 128-bit long, and the locator of the counterpart device transmitted to the external device from the gateway of the home mapping server in step S48 is 16-bit long. That is, the gateway of the home mapping server allocates a 16-bit locator of the counterpart device mapped to a 128-bit locator of the counterpart device and transmits the allocated 16-bit locator of the counterpart device to the external device.

Meanwhile, the embodiments of the present invention as described above can be constructed by a computer program that can be executed in a computer and can be implemented in a general-purpose digital computer that operates the program using a computer-readable recording medium.

The computer-readable recording medium includes recording media such as magnetic storage media (e.g., ROMs, floppy disks, hard disks, and the like), optical recording media (e.g., CD-ROMs, DVDs, and the like) and carrier waves (e.g., transmission through the Internet).

While the present invention has been described in connection with the exemplary embodiments illustrated in the drawings, they are merely illustrative and the invention is not limited to these embodiments. It will be appreciated by a person having an ordinary skill in the art that various equivalent modifications and variations of the embodiments can be made without departing from the spirit and scope of the present invention. Therefore, the true technical scope of the present invention should be defined by the technical spirit of the appended claims.

1. A method of supporting mobility of a device in a sensor network based on Internet Protocol Version (IPv6, the method comprising the steps of:
receiving, when an external device is moved to a personal area network of a home mapping server, a locator update request message containing an identifier and a locator of the external device from a gateway managing the personal area network;
determining whether or not the external device is an external device registered in an external mapping server based on the identifier of the external device;
transmitting, if the external device is an external device registered in the external mapping server), the identifier of the external device to the device management server, and requesting inquiry of a locator of the external mapping server, in which the external device is registered;
transmitting a locator change request message to the external mapping server, the locator change request message requesting a change of the locator of the external device, which contains a locator of the gateway and the identifier of the external device and is mapped to the identifier of the external device, to a location of the gateway; and
receiving a locator change response message as a result of changing the locator of the external device from the external mapping server in response to the locator change request message, and transmitting a locator update response message to the gateway.

2. The method according to claim 1, wherein the sensor network based on the Internet Protocol Version is 6LoWPAN.

3. The method according to claim 2, wherein the external device is a sensor node or a mobile network (NEMO) including a plurality of sensor nodes connected to a mobile router MR.

4. The method according to claim 3, further comprising the steps of:
receiving, when the moved external device is registered in the home mapping server, a locator update request message containing the identifier and the locator of the device from the gateway of the personal area network of the home mapping server to which the device has moved;
extracting the identifier and the locator of the device from the locator update request message, and changing the locator of the device mapped to the identifier of the device to the location of the gateway of the personal area network of the home mapping server; and
transmitting a locator update response message to the gateway of the personal area network of the home mapping server.

5. The method according to claim 3, wherein the device management server stores the identifier of the device and a locator of the home mapping server or the external mapping server in which the device are registered.

6. The method according to claim 5, wherein the external mapping server or the home mapping server stores the identifier of the external device and the locator mapped to the external device identifier, and
when receiving the locator change request message, the external mapping server or the home mapping server changes the locator of the external device mapped to the external device identifier to the location of the gateway.

7. The method according to claim 5, wherein registration request message or registration response message contains a dispatch header pattern field, a compressed header field, a mobility header dispatch field, and a data field,
wherein a pattern data informing the addition of mobility header dispatch is stored in the dispatch header pattern field,
wherein an identification data for distinguishing a registration request message from a registration response message is stored in the mobility header dispatch field, and
wherein a data field containing a data corresponding to the registration request message or the registration response message is added next to the mobility header dispatch field according to the identification data.

8. The method according to claim 7, wherein the dispatch header pattern field, the compressed header field, and the mobility header dispatch field are respectively 1-byte long, and the data field is 18-byte long in the case of the registration request message and 2-byte long in the case of the registration response message.

9. The method according to claim 8, wherein the data informing the mobility header dispatch added next to the compressed header field is stored in the sixth and seventh bits of the compressed header field, the identification data is stored in the first bit of the mobility header dispatch field, and a data representing the device identifier is stored in the 16 bytes among the data field of the registration request message.

10. The method according to claim 3, further comprising the steps of:
transmitting, when the external device registered in the external mapping server moves to a personal area network (PAN) of the home mapping server and connects to the gateway of the home mapping server while communicating with a counterpart device registered in a counterpart mapping server, a binding request message from the external mapping server to the gateway of the external mapping server to which the external device is connected before the movement;
blocking a communication session between the external device and the counterpart device by the gateway of the external mapping server based on the binding request message, and transmitting a binding information message containing a locator of the counterpart device to the gateway of the home mapping server to which the external device has move and connected; and
transmitting a binding update message to the gateway of the counterpart device from the gateway of the home mapping server to which the external device has moved and connected, and updating binding information between the external device and the counterpart device.

11. The method according to claim 3, further comprising the steps of:
receiving, after the external device registered in the external mapping server moves to a personal area network of the home mapping server and connects to the gateway of the home mapping server, an identifier of the counterpart device which it is desired for the external device to communicate with from the gateway of the home mapping server;
receiving a locator of the counterpart mapping server, in which the counterpart device is registered, from the device management server based on the received identifier of the counterpart device;
requesting the locator of the counterpart device from the counterpart mapping server based on the locator of the counterpart mapping server; and
transmitting the locator of the counterpart device to the gateway of the home mapping server, and establishing a communication session between the external device and the counterpart device.
